(19) United States
(12) Patent Application Publication
(10) Pub. No.: US 2025/0104985 A1
(43) Pub. Date: Mar. 27, 2025

(54) MASS SPECTROMETER

(71) Applicant: Micromass UK Limited, Wilmslow (GB)

(72) Inventors: David Langridge, Wilmslow (GB); Keith Richardson, Wilmslow (GB)

(73) Assignee: Micromass UK Limited, Wilmslow (GB)

(21) Appl. No.: 18/729,736

(22) PCT Filed: Jan. 17, 2023
(86) PCT No.: PCT/GB2023/050073

§ 371 Date: Jul. 17, 2024

(30) Foreign Application Priority Data
Jan. 18, 2022 (GB) 2200611.8

(51) Int. Cl. H01J 49/00; H01J 49/42

(52) U.S. Cl. CPC H01J 49/0031; H01J 49/4245; H01J 49/427

(57) ABSTRACT

There is provided a method of operating an electrostatic ion trap, the electrostatic ion trap including a plurality of electrodes, the method including setting the voltage of the plurality of electrodes to a first voltage map, wherein the voltage map is configured such that: at a first ion kinetic energy per unit charge (KE) range, more than a first percentage of ions are stable, at a second ion KE range, less than a second percentage of ions are stable, and at a third ion KE range, more than the first percentage of ions are stable, wherein the first percentage is at least 4 times greater than the second percentage, and wherein the second ion KE range is between the first ion KE range and the third ion KE range.

### FIELD

This specification relates to an electrostatic ion trap and methods of operating thereof. More particularly, although not exclusively, this specification relates to a method of operating an electrostatic ion trap, a method of operating a mass spectrometer, a computer readable medium, a computer program, a system, an electrostatic ion trap, a mass spectrometer, a further mass spectrometer, a further computer program, and a further system.

It is a non-exclusive aim of this disclosure to provide improved methods of operating an electrostatic ion trap, improved methods of operating a mass spectrometer, an improved electrostatic ion trap, and an improved mass spectrometer.

### BACKGROUND

It is known to operate electrostatic ion traps as part of charge detection mass spectrometers to determine ion mass-to-charge ratios, ion charges, and ion masses.

### SUMMARY

There is provided a method of operating an electrostatic ion trap, the electrostatic ion trap including a plurality of electrodes,
the method including setting the voltage of the plurality of electrodes to a first voltage map,
wherein the voltage map is configured such that:
at a first ion kinetic energy per unit charge (KE) range, more than a first percentage of ions are stable,
at a second ion KE range, less than a second percentage of ions are stable, and
at a third ion KE range, more than the first percentage of ions are stable,
wherein the first percentage is at least four times greater than the second percentage,
and wherein the second ion KE range is between the first ion KE range and the third ion KE range.

The first percentage may be at least: 1; or 5; or 10; 20; or 30; or 40; or 50; or 60; or 70; or 80; or 90; or 95; or 96; or 97; or 98; or 99; or 99.5; or 99.9; or 99.99 percent.

The first percentage may be at least: 5; or 6; or 7; or 8; or 9; or 10; or 15; or 20; or 25; or 30; or 35; or 40; or 50; or 100; or 1,000; or 10,000; or 100,000; or 1,000,000; or 1,000,000,000 times greater than the second percentage.

The method may further include introducing a first ion into the electrostatic ion trap at a first ion KE.

The method may further include obtaining first CDMS data indicative of the first ion.

The first ion may be introduced into the electrostatic ion trap through an ion energy filter(s) having a first acceptance ion KE range corresponding to the first ion KE range and/or a second acceptance ion KE range corresponding to the third ion KE range.

The first ion may be a reference ion of known mass-to-charge ratio and/or ion mass and/or ion charge.

The first ion KE may be within the first or third ion KE range.

The method may further include changing the first voltage map to a second voltage map, such that the first ion KE is changed to a first adjusted ion KE. The first adjusted ion KE may be within the first or third ion KE range.

The method may further include obtaining second CDMS data indicative of the first adjusted ion KE.

The first ion may be introduced into the electrostatic ion trap from a first ion source.

The method may further include introducing a second ion into the electrostatic ion trap at a second ion KE.

The method may further include obtaining third CDMS data indicative of the first ion and the second ion simultaneously. The method may further include obtaining third CDMS data indicative of the first ion and the second ion sequentially.

The second ion may be introduced into the electrostatic ion trap through the ion energy filter(s) having the first acceptance ion KE range corresponding to the first ion KE range and/or the second acceptance ion KE range corresponding to the third ion KE range.

The second ion may be a reference ion of known mass-to-charge ratio and/or ion mass and/or ion charge.

The second ion KE may be within the first or third ion KE range.

The first ion KE may be within the first ion KE range and the second ion KE may be within the third ion KE range.

The first ion KE may be within the third ion KE range and the second ion KE may be within the first ion KE range.

The method may further include changing the first voltage map to the second voltage map, such that the first ion KE is changed to the first adjusted ion KE, and/or the second ion KE is changed to a second adjusted ion KE. The first adjusted ion KE may be within the first or third ion KE range and/or the second adjusted ion KE may be within the first or third ion KE range.

The method may further include obtaining fourth CDMS data indicative of the first adjusted ion KE and the second ion adjusted ion KE simultaneously. The method may further include obtaining fourth CDMS data indicative of the first adjusted ion KE and the second ion adjusted ion KE sequentially.

The electrostatic ion trap may have a first end and a second end.

The method may further include introducing the first ion into the electrostatic ion trap and then introducing the second ion into the electrostatic ion trap at the second end when the first ion is at the first end of the electrostatic ion trap.

The method may further include introducing the first ion into the electrostatic ion trap and then introducing the second ion into the electrostatic ion trap at the first end when the first ion is at the second end of the electrostatic ion trap.

The first ion may be introduced into the electrostatic ion trap from a first ion source and/or the second ion may be introduced from a second ion source.

There is also provided a method of operating a mass spectrometer, comprising the method of operating an electrostatic ion trap as described above.

There is also provided a computer readable medium having instructions stored thereon which, when executed by a processor, cause the performance of a method as described above of operating an electrostatic ion trap.

There is also provided a computer program including instructions which, when executed by a processor, cause the performance of a method as described above of operating an electrostatic ion trap.

There is also provided a system including at least one processor and a computer readable medium, wherein the computer readable medium has instructions stored thereon which, when executed by the at least one processor, cause the system to perform a method as described above of operating an electrostatic ion trap.

The system may include a processor and a computer readable medium. The computer readable medium may be configured to store instructions for execution by the processor. The processor may include a number of sub-processors which may be configured to work together, e.g. in parallel with each other, to execute the instructions. The sub-processors may be geographically and/or physically separate from each other and may be communicatively coupled to enable coordinated execution of the instructions.

There is also provided an electrostatic ion trap including at least one processor and a computer readable medium, wherein the computer readable medium has instructions stored thereon which, when executed by the at least one processor, cause the electrostatic ion trap to perform a method as described above of operating an electrostatic ion trap.

The electrostatic ion trap may include a processor and a computer readable medium. The computer readable medium may be configured to store instructions for execution by the processor. The processor may include a number of sub-processors which may be configured to work together, e.g. in parallel with each other, to execute the instructions. The sub-processors may be geographically and/or physically separate from each other and may be communicatively coupled to enable coordinated execution of the instructions.

There is also provided a mass spectrometer system including at least one processor and a computer readable medium, wherein the computer readable medium has instructions stored thereon which, when executed by the at least one processor, cause the mass spectrometer system to perform a method as described above of operating an electrostatic ion trap.

There is also provided a further mass spectrometer system including at least one processor and a computer readable medium, wherein the computer readable medium has instructions stored thereon which, when executed by the at least one processor, cause the mass spectrometer system to perform a method as described above of a mass spectrometer.

A further computer program is also provided. The further computer program includes instructions which, when the program is executed by a processor, cause the performance of a method described above of operating a mass spectrometer.

There is also provided a computer readable medium having instructions stored thereon which, when executed by a processor, cause the performance of operating a mass spectrometer.

There is also provided a further system including at least one processor and a computer readable medium, wherein the computer readable medium has instructions stored thereon which, when executed by the at least one processor, cause the further system to perform a method as described above of operating a mass spectrometer.

The further system may include a processor and a computer readable medium. The computer readable medium may be configured to store instructions for execution by the processor. The processor may include a number of sub-processors which may be configured to work together, e.g. in parallel with each other, to execute the instructions. The sub-processors may be geographically and/or physically separate from each other and may be communicatively coupled to enable coordinated execution of the instructions.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a representative graph of ion stability against ion kinetic energy for a prior art electrostatic ion trap;

FIG. 2 is a representative graph of ion stability against ion kinetic energy according to an embodiment;

FIG. 3 is a representative graph of signal intensity against ion kinetic energy standard deviation for a prior art electrostatic ion trap;

FIG. 4 is a representative graph of signal intensity against ion kinetic energy standard deviation according to an embodiment; and

FIG. 5 shows a cross-sectional side view of an electrostatic ion trap in operation according to an embodiment.

### DETAILED DESCRIPTION OF THE DISCLOSURE

Charge detection mass spectrometry (CDMS) is an emerging technology that enables characterization of large, highly-charged and heterogeneous analytes such as whole virus capsids that are of increasing importance in next-generation biotherapeutics. CDMS analysis can be carried out in electrostatic ion traps. Ions may oscillate back and forth between two reflectrons (generally located at longitudinal ends of the electrostatic ion trap), repeatedly passing a detection electrode (e.g. central charge-detection electrode). For a given electrostatic ion trap geometry (e.g. a voltage map of electrode(s) and/or a configuration, e.g. number, of electrode(s) in the electrostatic ion trap) and known ion energy per unit charge (ion KE), the mass-to-charge ratio (m/z) of an ion may be determined from its ion oscillation frequency, while the measured signal amplitude (from CDMS data indicative of the ion) can be used to determine the charge (z) on the ion. The product of m/z and z yields the ion mass.

In order to reach the required charge (z) accuracy (e.g. unit charge in some cases), long trapping times of hundreds of milliseconds are often required. One consequence of this is that when two or more ions of the same ion KE are trapped simultaneously, there may be a high probability that the ions will interact. These interactions may change the ion KEs of the ions, which may significantly complicate interpretation of the resulting data (e.g. CDMS data indicative of the ion(s)). Using traditional data analysis methods (Fast Fourier Transforms (FFT)), the result may be a significant reduction in an effective mass resolution of the CDMS and resultant CDMS data.

To avoid loss of mass resolution, CDMS devices are often operated in single-ion mode (i.e. a single ion will be trapped). This may greatly increase the time required to build up a mass spectrum (i.e. CDMS data indicative of an ion). In particular, it can take many hours to achieve the required data quality. This problem is exacerbated by the fact that, even with careful control of an incoming ion flux (e.g. ions to be introduced to an electrostatic ion trap), many attempted trapping events (i.e. an attempt to maintain an ion within the electrostatic ion trap in a stable manner) may result in no trapped ions or trapping of multiple ions (of potentially similar ion KEs). In particular, even when the ion arrival rate is optimized for single-ion trapping, the success rate may be no higher than approximately 37% in a random-trapping mode of operation.

It is therefore necessary to provide CDMS geometries and conditions (e.g. voltage maps) in which it is possible to trap more than one ion in trajectories that are less likely to interfere. With the possibility to analyse data from trapping events containing one or two ions, the optimal average number of trapped ions is 1.4 and the success rate for random trapping increases to 59%. When up to three ions are permitted, these numbers increase to 1.8 and 73% respectively.

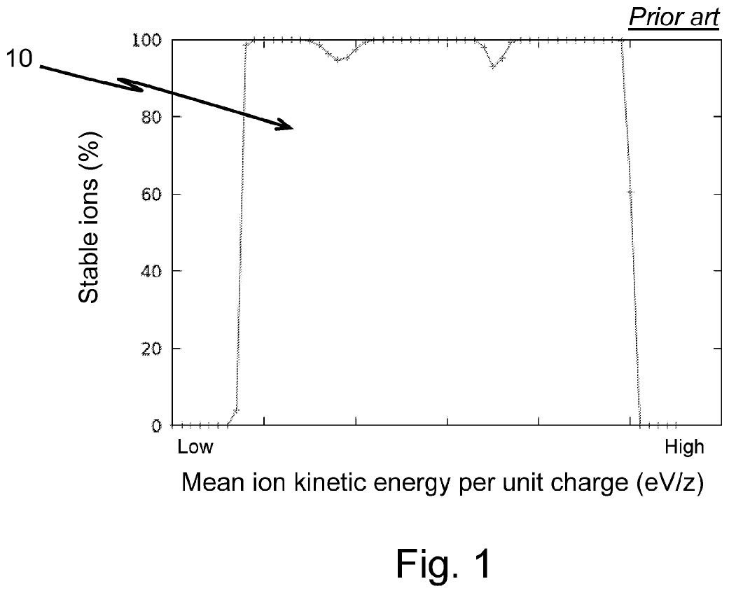

It is known to use electrostatic ion traps that may accommodate ions having a single, broad, continuous acceptance range of energies, as shown in FIG. 1. This approach can be problematic, however: if the energy of the incoming ions is known only to lie within a range then it must be inferred as part of the data analysis process (since a broad range of ion energies can be accepted by the trap); the range of ion energies that can be accommodated whilst maintaining a sufficiently high instrument resolution may be limited for practical reasons; if the incoming ion energies lie randomly within the acceptance range, it is still possible for ions having similar energies to be trapped simultaneously. Presence of multiple ions, ion interactions, and/or low signal intensity may provide challenges in accurately measuring and determining ion mass-to-charge ratios, ion charges, and ion masses.

To reduce these problems, we propose a new approach in which the trap is designed to yield acceptable resolutions for ions of two or more widely separated energies or energy ranges, as ions having different energies are less likely to interfere with each other.

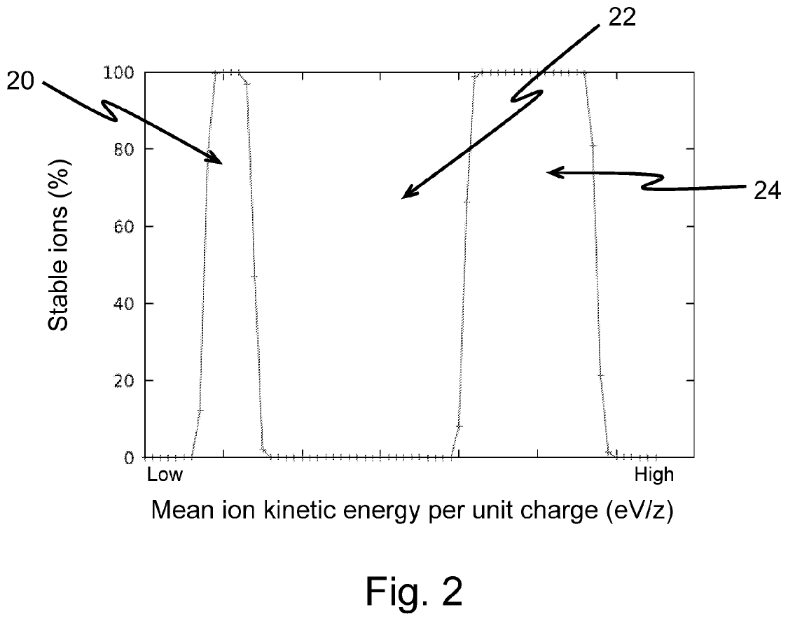

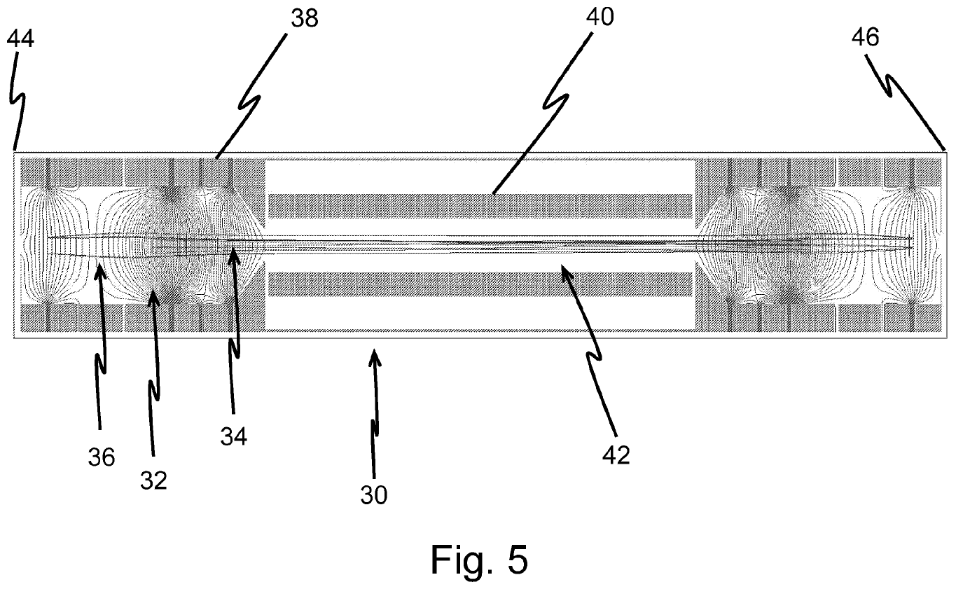

There is provided a method of operating an electrostatic ion trap 30, the electrostatic ion trap 30 including a plurality of electrodes 38 (as shown in a representative example in FIG. 5). The method includes setting the voltage of the plurality of electrodes 38 to a first voltage map. With reference to FIG. 2, the first voltage map is configured such that at a first ion kinetic energy per unit charge (KE) range 20, more than a first percentage of ions are stable, at a second ion KE range 22, less than a second percentage of ions are stable, and at a third ion KE range 24, more than the first percentage of ions are stable. The first percentage is at least 4 times greater than the second percentage. In other words, the voltage map is configured such that the first percentage is at least 4 times greater than the second percentage. The second ion KE range 22 is between the first ion KE range 20 and the third ion KE range 24. Ion kinetic energy per unit charge (KE) may be represented by the units of electron volts per unit charge (unit charge may otherwise be known as charge number), i.e. eV/z.

In other words, and as shown in FIG. 2, the first voltage map is configured to create a bimodal ion KE acceptance range in which ion stability is high at a first (e.g. lower) ion KE range 20 (i.e. a first percentage of ions are stable, e.g. more than 80 percent of ions may be stable as shown in FIG. 2), low at a second (e.g. intermediate) ion KE range 22 (i.e. a second percentage of ions are stable, e.g. less than 20 percent of ions may be stable as shown in FIG. 2), and high at a third (e.g. higher) ion KE range 24 (i.e. a first percentage of ions are stable, e.g. more than 80 percent of ions may be stable as shown in FIG. 2). If an ion is stable in the electrostatic ion trap 30, the ion will oscillate between the ends of a trap (e.g. between a first end 44 and a second end 46 as shown in FIG. 5). If an ion is unstable in the electrostatic ion trap 30, the oscillation may be unstable, such that the ion does not travel along a central axis of the electrostatic ion trap 30, and may hit a wall of a detector tube 40, for example.

The first percentage may be at least: 5; or 6; or 7; or 8; or 9; or 10; or 15; or 20; or 25; or 30; or 35; or 40; or 50; or 100; or 1,000; or 10,000; or 100,000; or 1,000,000; or 1,000,000,000 times greater than the second percentage, or any value or range therebetween. The first percentage may be greater than the second percentage by a value represented by a range, e.g. the first percentage may be four to five times greater than the second percentage. When the first percentage is greater than the second percentage by a value represented by a range in this way, the first ion KE range 20 may have a percentage of ions that are stable that is different to the third ion KE range 24; for example, the first ion KE range 20 may have a percentage of ions that are stable that is four times greater than the second percentage (at the second ion KE range 22), and the third ion KE range 24 may have a percentage of ions that are stable that is five times greater than the second percentage. It will be appreciated that the first percentage may be greater than the second percentage by a non-integer value (e.g. 4.5).

The first voltage map may be configured such that at the first ion KE range 20, more than 99.99 percent of ions are stable; or more than 99.9 percent of ions are stable; or more than 99.5 percent of ions are stable; or more than 99 percent of ions are stable; or more than 98 percent of ions are stable; or more than 97 percent of ions are stable; or more than 95 percent of ions are stable; or more than 90 percent of ions are stable; or more than 80 percent of ions are stable, or more than 70 percent of ions are stable; or more than 60 percent of ions are stable; or more than 50 percent of ions are stable; or more than 40 percent of ions are stable; or more than 30 percent of ions are stable; or more than 20 percent of ions are stable; or more than 10 percent of ions are stable; or more than 5 percent of ions are stable; or more than 1 percent of ions are stable. In other words, the first percentage may be 1; or 5; or 10; or 20; or 30; or 40; or 50; or 60; or 70; or 80; or 90; or 95; or 96; or 97; or 98; or 99; or 99.5; or 99.9; or 99.99 percent.

The first voltage map may be configured such that at a second ion KE range 22, less than 40 percent of ions are stable; or less than 30 percent of ions are stable; or less than 20 percent of ions are stable; or less than 10 percent of ions are stable; or less than 5 percent of ions are stable. In other words, the second percentage may be at most 40 percent, or 30 percent, or 20 percent, or 10 percent, or 5 percent; or 1 percent; or 0.1 percent; or 0.01 percent; or 0.001 percent; or 0.0001 percent.

The first voltage map may be configured such that at a third ion KE range 24, more than 99.99 percent of ions are stable; or more than 99.9 percent of ions are stable; or more than 99.5 percent of ions are stable; or more than 99 percent of ions are stable; or more than 98 percent of ions are stable; or more than 97 percent of ions are stable; or more than 95 percent of ions are stable; or more than 90 percent of ions are stable; or more than 80 percent of ions are stable, or more than 70 percent of ions are stable; or more than 60 percent of ions are stable; or more than 50 percent of ions are stable; or more than 40 percent of ions are stable; or more than 30 percent of ions are stable; or more than 20 percent of ions are stable; or more than 10 percent of ions are stable; or more than 5 percent of ions are stable; or more than 1 percent of ions are stable. In other words, and as described above in respect of the first ion KE range 20, the first percentage may be 1; or 5; or 10; or 20; or 30; or 40; or 50; or 60; or 70; or 80; or 90; or 95; or 96; or 97; or 98; or 99; or 99.5; or 99.9; or 99.99 percent.

Methods of operating electrostatic ion traps 30 as described above may provide advantages. In particular, as described above, ions trapped within the electrostatic ion trap 30 having similar ion Kes may have similar oscillation trajectories within the electrostatic ion trap 30, such that there may be interactions between the ions, whilst ions having different ion KEs are less likely to interfere with each other. Accordingly, the method as described above may resulting in a higher mass resolution than when using a voltage map that allows for a high ion KE across a broad range of KE (as shown in FIG. 1, represented by area 10).

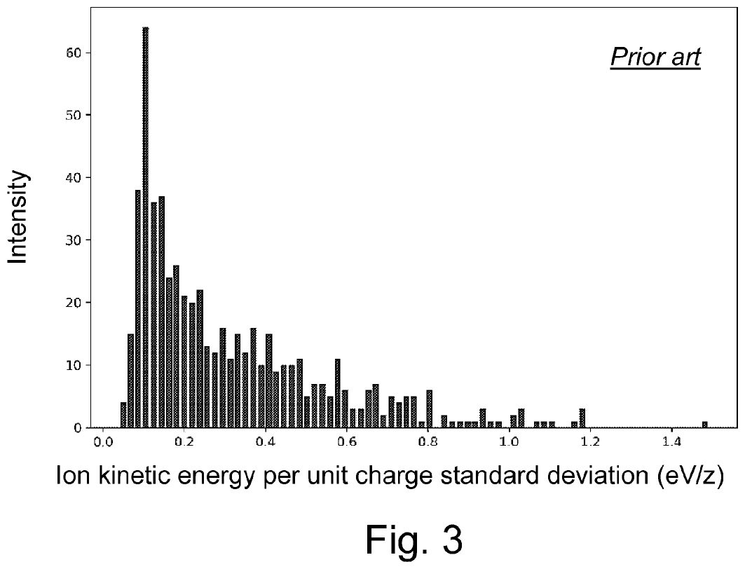

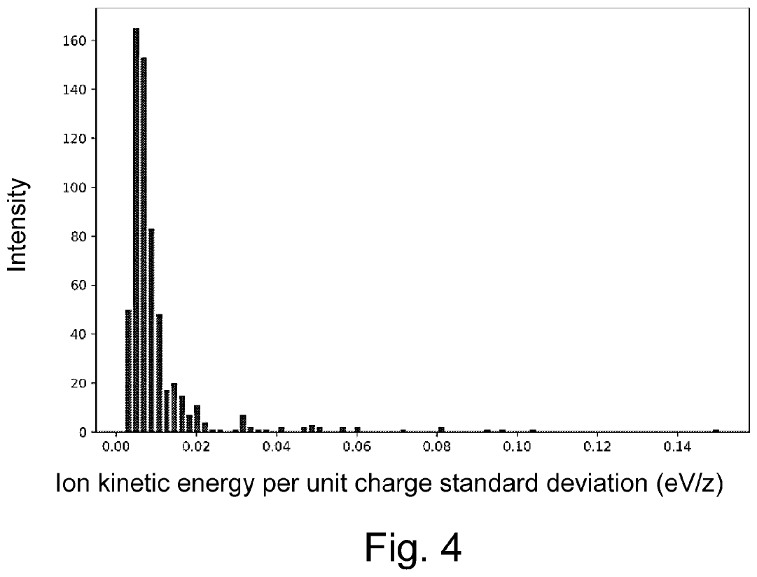

Further, as shown in FIGS. 3 and 4, the standard deviation of ion KE signals may be much lower for the method as described above than for known prior art methods including a broad acceptance range of ion kinetic energies. In particular, the standard deviation of the known prior art method in the representative example has standard deviation values of a factor of ten to one-hundred times greater than the method as described above. Accordingly, the energy resolution and hence the mass resolution of the method as described above may be greater than known prior art methods. This greater energy and mass resolution may be a result of a reduction, or elimination, of space-charge between the ions as may occur between ions of similar energies in known methods. Furthermore, due to the high energy and mass resolution and low standard deviation, the method may provide for increased confidence that the first ion or second ion that has been introduced at desired ion KE. In particular, an ion may be introduced into the electrostatic ion trap at an unknown or not precisely known ion KE; for example, the ion KE may be known to be within a particular broad ion KE range, but not a specific ion KE (or a narrow ion KE range). Since an ion's mass-to-charge ratio (m/z) may be determined from an oscillation frequency of an ion of known ion KE, and ion charge (z) may be determined from the measured signal amplitude of an ion of known KE, if an ion of an unknown ion KE is introduced into an electrostatic ion trap of broad ion acceptance (as shown in FIG. 1), accurately determining the ion KE, and hence the ion's mass-to-charge ratio (m/z) and ion charge (z) may not be possible. On the contrary, if an ion of an unknown ion KE or a known broad range of ion KEs is introduced into the electrostatic ion trap 30 as described above (e.g. including the voltage map as described above), then if the ion remains stable and oscillates stably, the ion KE may be determined to be within a narrow ion KE range (e.g. the first ion KE range 20 or the third ion KE range 24). In other words, the method as described above may allow for increased confidence that an ion KE has been determined accurately, and hence may allow for increased confidence that the ion m/z and z has been determined accurately. Further, if an ion is introduced that has an ion KE of a value outside the first or third ion KE range 20, 24, then the ion may not be stable in the electrostatic ion trap 30 and a signal representative of an ion intensity may not be produced, resulting in confirmation that an ion was introduced into the electrostatic ion trap 30 outside of a desired ion KE. Furthermore, even if the ion acceptance in the first and third ion KE ranges 20, 24 is low (e.g., where the first percentage is 1 percent), advantages may still be achieved as described above. For example, if the first percentage is at least 1 percent, since the first percentage is at least 4 times greater than the second percentage, if 1000 ions are introduced into the electrostatic ion trap 30, on average approximately at least 10 ions with ion KE values in the first and/or third ion KE ranges 20, 24 would be trapped within the first ion KE range 20 and/or the third ion KE range 24 and on average at most 2 ions with ion KE values within the second ion KE range 22 would be trapped within the second ion KE range 22. This advantage may have increased effect if the first percentage is greater than the second percentage by a large value (e.g. 10 times, or 100 times, or 1000 times, etc., greater), such that the ion stability within the second ion KE range 22 may not allow for statistically any ions to be stable in the second ion KE range.

The method may further include introducing a first ion into the electrostatic ion trap 30 at a first ion KE.

The method may further include obtaining first CDMS data indicative of the first ion. The first CDMS data indicative of the first ion may be indicative of a property of the first ion. For example, the first CDMS data indicative of the first ion may be indicative of ion KE, and/or ion mass-to-charge ratio (m/z), and/or ion charge (z), and/or ion mass (m) of the first ion.

The first ion may be introduced into the electrostatic ion trap 30 through an ion energy filter(s) having a first acceptance ion KE range corresponding to the first ion KE range 20 and/or a second acceptance ion KE range corresponding to the third ion KE range 24.

Introducing the first ion into the electrostatic ion trap 30 through an ion energy filter(s) having a first acceptance ion KE range corresponding to the first ion KE range 20 and/or a second acceptance ion KE range corresponding to the third ion KE range 24 may provide advantages. In particular, the filter may reduce the probability of an ion being introduced into the electrostatic ion trap 30 at an ion KE corresponding to the second ion KE range. In other words, the energy filter(s) may allow only ions having ion Kes corresponding to the first ion KE range 20 or third ion KE range 24 into the electrostatic ion trap 30, such that the first ion introduced into the electrostatic ion trap 30 is stable (e.g. oscillates stably) within the electrostatic ion trap 30. Accordingly, the probability of a successful trapping event may be increased, and/or the confidence of the accuracy of a determined ion KE, and therefore the accuracy of the determined ion mass-to charge ratio (m/z) and/or charge (z), and/or mass (m) may be increased.

The first ion may be a reference ion of known mass-to-charge ratio and/or ion mass and/or ion charge and/or ion KE.

Including a reference ion in the method as described above may provide advantages. In particular, CDMS data indicative of the reference ion (e.g. signals representative of the ion KE, and/or mass-to-charge ratio, and/or ion charge, and/or ion mass of the reference ion) may be obtained and analysed to determine, account for, and correct for effects that may perturb ion mass-to-charge, and/or ion charge measurements. Effects that may perturb measurements of ions include ambient temperature sensitivity of electronics and/or changes of pressure inside the electrostatic ion trap 30. CDMS data indicative of the reference ion may be indicative of a property of the reference ion. For example, the first CDMS data indicative of the reference ion may be indicative of ion KE, and/or ion mass-to-charge ratio (m/z), and/or ion charge (z), and/or ion mass (m) of the reference ion.

The first ion KE may be within the first or third ion KE range 20, 24.

As described above, having a first ion KE within the first or third ion KE range 20, 24 may increase the probability of a successful trapping event. Accordingly, the probability that the first ion may oscillate stably within the electrostatic ion trap 30 may be increased.

The method may further include changing the first voltage map to a second voltage map, such that the first ion KE is changed to a first adjusted ion KE. The first adjusted ion KE may be within the first or third ion KE range 20, 24. The second voltage map may have any of, any combination of, or all of the features and/or associated advantages of the first voltage map; particularly with respect to ion stability at the first ion KE range, the second ion KE range, and/or the third ion KE range.

Changing the first voltage map to a second voltage map may provide advantages. In particular, if the first ion KE range 20 or the third ion KE range 24 is adjudged to have a lower mass resolution than the other as described above, and if the first ion KE is within the range of the ion KE range with a lower mass resolution than the other (e.g. the first ion KE range 20 or the third ion KE range 24), then the first adjusted ion KE resultant from the change of the first voltage map to the second voltage map may correspond to the ion KE range with a higher mass resolution.

The method may further include obtaining second CDMS data indicative of the first adjusted ion KE. The second CDMS data indicative of the first adjusted ion KE (i.e. CDMS data indicative of the first ion at the first adjusted ion KE) may be indicative of a property of the first ion (at the adjusted ion KE). For example, the second CDMS data indicative of the first adjusted ion KE (i.e. the first ion at the first adjusted ion KE) may be indicative of ion KE, and/or ion mass-to-charge ratio (m/z), and/or ion charge (z), and/or ion mass (m) of the first ion (at the first adjusted ion KE).

The first ion may be introduced into the electrostatic ion trap 30 from a first ion source.

The method may further include introducing a second ion into the electrostatic ion trap 30 at a second ion KE.

Introducing a second ion into the electrostatic ion trap 30 at a second ion KE may provide advantages. In particular, the electrostatic ion trap 30 may be used to analyse the first and second ions simultaneously.

The method may further include obtaining third CDMS data indicative of the first ion and/or the second ion. The method may further include obtaining third CDMS data indicative of the first ion and the second ion simultaneously. The third CDMS data indicative of the first ion and/or the second ion may be indicative of a property of the first ion and/or the second ion. For example, the first CDMS data indicative of the first ion and/or the second ion may be indicative of ion KE, and/or ion mass-to-charge ratio (m/z), and/or ion charge (z), and/or ion mass (m) of the first ion and/or the second ion.

Obtaining third CDMS data indicative of the first ion and the second ion simultaneously may provide advantages. In particular, the analysis process may be faster, and the accuracy of the results (e.g. mass resolution of an ion) may be equivalent or better than results obtained from known methods of analysis requiring a single ion to be trapped at a time, e.g. if the first ion and/or the second ion is a reference ion of known ion KE (as described below), CDMS data indicative of the reference ion (e.g. signals representative of the ion KE, mass-to-charge ratio, ion charge, and therefore ion mass) may be analysed to determine, account for, and correct for effects that may perturb ion mass-to-charge, and/or ion charge measurements. Effects that may perturb measurements of ions include ambient temperature sensitivity of electronics and/or changes of pressure inside the electrostatic ion trap 30.

The method may further include obtaining third CDMS data indicative of the first ion and the second ion sequentially. The third CDMS data indicative of the first ion and second ion may be indicative of a property of the first ion and the second ion. For example, the first CDMS data indicative of the first ion and the second ion may be indicative of ion KE, and/or ion mass-to-charge ratio (m/z), and/or ion charge (z), and/or ion mass (m) of the first ion and/or the second ion.

The second ion may be introduced into the electrostatic ion trap 30 through the ion energy filter(s) having the first acceptance ion KE range corresponding to the first ion KE range 20 and/or the second acceptance ion KE range corresponding to the third ion KE range 24.

Introducing the second ion into the electrostatic ion trap 30 through an ion energy filter(s) having the first acceptance ion KE range corresponding to the first ion KE range 20 and/or a second acceptance ion KE range corresponding to the third ion KE range 24 may provide advantages. In particular, the filter may reduce the probability of an ion being introduced into the electrostatic ion trap 30 at an ion KE corresponding to the second ion KE range 22. In other words, the energy filter(s) may allow only ions having ion KEs corresponding to the first ion KE range 20 or third ion KE range 24 into the electrostatic ion trap 30, such that the second ion introduced into the electrostatic ion trap 30 is stable (e.g. oscillates stably) within the electrostatic ion trap 30. Accordingly, the probability of a successful trapping event may be increased.

The second ion may be a reference ion of known mass-to-charge ratio and/or ion mass and/or ion charge and/or ion KE.

Including a reference ion in the method as described above may provide advantages. In particular, CDMS data indicative of the reference ion (e.g. signals representative of the ion KE, mass-to-charge ratio, ion charge, and therefore ion mass) may be analysed to determine, account for, and correct for effects that may perturb ion mass-to-charge, and/or ion charge measurements. Effects that may perturb measurements of ions include ambient temperature sensitivity of electronics and/or changes of pressure inside the electrostatic ion trap 30.

The second ion KE may be within the first or third ion KE range 20, 24.

As described above, having a second ion KE within the first or third ion KE range 20, 24 may increase the probability of a successful trapping event. Accordingly, the probability that the second ion may oscillate stably within the electrostatic ion trap 30 may be increased.

The first ion KE may be within the first ion KE range 20 and the second ion KE may be within the third ion KE range 24.

The first ion KE may be within the third ion KE range 24 and the second ion KE may be within the first ion KE range 20.

In other words, since the first voltage map provides two ion KE ranges (i.e. the first and third ion KE ranges 20, 24) in which ion stability is high (e.g. more than 80 percent of ions are stable), as described above, the first ion and second ion may have KEs within the two ion KE ranges, but each ion may not be located within the same ion KE range. Accordingly, when the first ion is in a different ion KE range to the second ion, interactions between the first ion and second ion may be reduced, and confidence in the data obtained may be increased as described above.

The method may further include changing the first voltage map to the second voltage map, such that the first ion KE is changed to the first adjusted ion KE, and/or the second ion KE is changed to a second adjusted ion KE. The first adjusted ion KE may be within the first or third ion KE range 20, 24 and/or the second adjusted ion KE may be within the first or third ion KE range 20, 24.

Changing the first voltage map to a second voltage map as described above may provide advantages. In particular, the second voltage map may be selected such that the first ion and second ion adjusted KEs are located in the first and third ion KE range 20, 24. For example, if the first ion KE is located within the third ion KE range 24, the first adjusted ion KE range may be located within the first ion KE range 20; additionally or alternatively, if the second ion KE is located within the third ion KE range 24, the second adjusted KE may be located within the first ion KE range 20.

The first ion KE range 20 may have a higher mass resolution than the third ion KE range 24, or the third ion KE range 24 may have a higher mass resolution than the first ion KE range 20.

With reference to FIG. 5, an ion oscillating in the electrostatic ion trap 30 will have a duty cycle. A duty cycle may be defined as the proportion of time the ion is in a detector tube 40 of the electrostatic ion trap 30 (i.e. when the ion signal is being measured) in relation to the time spent outside of the detector tube 40. For example, an ion with a duty cycle of 50 percent spends 50 percent of its time during a complete oscillation within the detector tube 40 (i.e. in an electric field-free region 42). Ion oscillation frequency is dependent upon the KE of the ion; the time spent in the detector tube 40 does not change for the same ion with a different KE, but the time spent outside of the detector tube 40 is altered (e.g. an ion with a larger ion KE may travel further into an electric field region 32 of the electrostatic ion trap 30, as shown in FIG. 5). Therefore, the proportion of time the ion spends within the detector tube 40 may be different for the ions of KEs corresponding to the first and third ion KE ranges 20, 24. Accordingly, introducing ions of two different KEs may result in ions of two different oscillation frequencies, and therefore different duty cycles. Therefore, an ion with a lower KE may have a higher oscillation frequency (shown in FIG. 5 as a first ion path 34) than an ion with a higher KE may have a lower oscillation frequency (shown in FIG. 5 as a second ion path 36).

It has been determined that a duty cycle of approximately 50 percent provides optimal mass resolution of a measured signal. Therefore, an ion with a KE corresponding to the first or third ion KE range 20, 24 may have a duty cycle closer to 50 percent than an ion at the other ion KE range (e.g. the first ion KE range 20 may result in an ion duty cycle closer to 50 percent than the third ion KE range 24). Accordingly, one KE range (e.g. the first ion KE range 20 or the third ion KE range 24) may provide a higher measured mass resolution than the other.

If it is determined that the first ion KE range 20 has a higher mass resolution than the third ion KE range 24, or the third ion KE range 24 may have a higher mass resolution than the first ion KE range 20, as described above, then the reference ion, if present, may be introduced at an ion energy within the range of the ion KE range with a lower mass resolution. Accordingly, since the reference ion may be of known mass-to-charge ratio (m/z), ion charge (z), and ion mass (m), the effect of a lower mass resolution may be of lower importance than for an ion for which the ion KE (and/or ion m, and/or m/z, and/or m) values are not known (e.g. the first ion or second ion that is not a reference ion).

The method may further include obtaining fourth CDMS data indicative of the first adjusted ion KE and/or the second adjusted ion KE. The method may further include obtaining fourth CDMS data indicative of the first adjusted ion KE and the second adjusted ion KE simultaneously. The method may further include obtaining fourth CDMS data indicative of the first adjusted ion KE and the second ion adjusted ion KE sequentially. The fourth CDMS data indicative of the first adjusted ion KE and/or the section ion adjusted ion KE (i.e. CDMS data indicative of the first ion at the first adjusted ion KE and/or the second ion at the second adjusted ion KE) may be indicative of a property of the first ion (at the first adjusted ion KE) and/or the second ion (at the second ion adjusted KE). For example, the fourth CDMS data indicative of the first adjusted ion KE (i.e. the first ion at the first adjusted ion KE) and/or the second adjusted ion KE (i.e. the second ion at the second adjusted ion KE) may be indicative of ion KE, and/or ion mass-to-charge ratio (m/z), and/or ion charge (z), and/or ion mass (m) of the first ion and/or the second ion.

The electrostatic ion trap 30 may have a first end 44 and a second end 46.

The method may further include introducing the first ion into the electrostatic ion trap 30 and then introducing the second ion into the electrostatic ion trap 30 at the second end 46 when the first ion is at the first end 44 of the electrostatic ion trap 30.

The method may further include introducing the first ion into the electrostatic ion trap 30 and then introducing the second ion into the electrostatic ion trap 30 at the first end 44 when the first ion is at the second end 46 of the electrostatic ion trap 30.

Introducing the second ion into the electrostatic ion trap 30 at the second end 46 when the first ion is at the first end 44 of the electrostatic ion trap 30, or introducing the second ion into the electrostatic ion trap 30 at the first end 44 when the first ion is at the second end 46 of the electrostatic ion trap 30 may provide advantages. In particular, the potential for interaction between the first ion and the second ion may be reduced.

The first ion may be introduced into the electrostatic ion trap 30 from a first ion source and/or the second ion may be introduced from a second ion source.

Introducing the first ion into the electrostatic ion trap 30 from a first ion source and/or the second ion into the electrostatic ion trap 30 a second ion source may provide advantages. In particular, introducing the first ion and second ion from different ion sources (i.e. the first and second ion sources) may reduce the chances of the first ion and second ion when being introduced into the the electrostatic ion trap 30 and also once within the electrostatic ion trap 30.

There is also provided a method of operating a mass spectrometer, comprising a method as described above of operating an electrostatic ion trap 30.

There is also provided a computer readable medium having instructions stored thereon which, when executed by a processor, cause the performance a method as described above of operating an electrostatic ion trap 30.

There is also provided a computer program including instructions which, when executed by a processor, cause the performance of a method described above of operating an electrostatic ion trap 30.

There is also provided a system including at least one processor and a computer readable medium, wherein the computer readable medium has instructions stored thereon which, when executed by the at least one processor, cause the system to perform a method described above of operating an electrostatic ion trap 30.

The system may include a processor and a computer readable medium. The computer readable medium may be configured to store instructions for execution by the processor. The processor may include a number of sub-processors which may be configured to work together, e.g. in parallel with each other, to execute the instructions. The sub-processors may be geographically and/or physically separate from each other and may be communicatively coupled to enable coordinated execution of the instructions.

There is also provided an electrostatic ion trap 30 including at least one processor and a computer readable medium, wherein the computer readable medium has instructions stored thereon which, when executed by the at least one processor, cause the electrostatic ion trap 30 to perform a method as described above of operating an electrostatic ion trap 30.

The electrostatic ion trap 30 may include a processor and a computer readable medium. The computer readable medium may be configured to store instructions for execution by the processor.

The processor may include a number of sub-processors which may be configured to work together, e.g. in parallel with each other, to execute the instructions. The sub-processors may be geographically and/or physically separate from each other and may be communicatively coupled to enable coordinated execution of the instructions.

There is also provided a mass spectrometer system including at least one processor and a computer readable medium, wherein the computer readable medium has instructions stored thereon which, when executed by the at least one processor, cause the mass spectrometer system to perform a method as described above of operating an electrostatic ion trap 30.

There is also provided a further mass spectrometer system including at least one processor and a computer readable medium, wherein the computer readable medium has instructions stored thereon which, when executed by the at least one processor, cause the mass spectrometer system to perform a method as described above of operating a mass spectrometer.

A further computer program is also provided. The further computer program includes instructions which, when the program is executed by a processor, cause the performance of a method described above of operating a mass spectrometer.

There is also provided a computer readable medium having instructions stored thereon which, when executed by a processor, cause the performance of operating a mass spectrometer.

There is also provided a further system including at least one processor and a computer readable medium, wherein the computer readable medium has instructions stored thereon which, when executed by the at least one processor, cause the further system to perform a method as described above of operating a mass spectrometer.

The further system may include a processor and a computer readable medium. The computer readable medium may be configured to store instructions for execution by the processor. The processor may include a number of sub-processors which may be configured to work together, e.g. in parallel with each other, to execute the instructions. The sub-processors may be geographically and/or physically separate from each other and may be communicatively coupled to enable coordinated execution of the instructions.

The computer readable medium may be any desired type or combination of volatile and/or non-volatile memory such as, for example, static random access memory (SRAM), dynamic random access memory (DRAM), flash memory, read-only memory (ROM), and/or a mass storage device (including, for example, an optical or magnetic storage device).

The system including the processor and computer readable medium, may be provided in the form of a server, a desktop computer, a laptop computer, or the like.

Further examples are provided below and may be applied to any of, any combination of, or all of the method, the electrostatic ion trap, the computer readable medium, the computer program, and/or the system as described above.

The method(s) may include carrying out following in the order of: a) introducing the first ion into the electrostatic ion trap 30 at a first ion KE, b) setting the voltage of the plurality of electrodes 38 to the first voltage map, c) introducing the second ion into the electrostatic ion trap 30 at the second ion KE, d) obtaining first CDMS data indicative of the first and second ion.

The first ion KE range 20 may have an upper ion KE value equivalent to a lower ion KE value of the second ion KE range 22, and/or the second ion KE range 22 may have an upper ion KE value equivalent to a lower ion KE value of the third ion KE range 24. In other words, the first, the second and the third ion KE ranges 22, 24 may abut each other. Additionally or alternatively, there may be gaps (i.e. ranges) in ion KE between the first ion KE range 20 and the second ion KE range 22 and/or the second ion KE range 22 and the third ion KE range 24.

The method(s) as described above may provide advantages. In particular, data analysis of e.g. the first CDMS data or second CDMS data may be informed by known transient shapes (or patterns or harmonics of the ions) for ions of different (or known) energies (e.g. KEs), and operating parameters may also be informed by known transient shapes (or patterns or harmonics of the ions). For example, if it is known that a voltage map produces known transient shapes, e.g. if a voltage map will result in a first ion having a first ion KE in the first ion KE range and a second ion having a second ion KE in the third ion KE range, then the voltage map may be pre-selected to ensure the first ion and second ion are successfully trapped and will successfully oscillate within the stable ion KE ranges (e.g. the first and third ion KE ranges 20, 24).

The first and/or second voltage map may be further configured such that at a fourth ion KE range, less than the second percentage of ions are stable, and/or at a fifth ion KE range more than the first percentage of ions are stable. The fourth ion KE range may be between the third ion KE range and the fifth ion KE range. In other words, the first and/or second voltage map may be configured such that there are a plurality of ion KE ranges (e.g. 4, or 5, or 6, or 7, or 8, or 9, or 10, or 15, or 20 ion KE ranges). At each odd-numbered ion KE range, more than the first percentage of ions may be stable, and/or at each even-numbered ion KE range, less than the second percentage of ions may be stable. Alternatively, at each even-numbered ion KE range, more than the first percentage of ions may be stable, and/or at each odd-numbered ion KE range, less than the second percentage of ions may be stable. In other words, for example, at an N^{th} ion KE range, less than a second percentage of ions may be stable, and at an (N−1)^{th} ion KE range and an (N+1)^{th} ion KE range, more than a first percentage of ions may be stable (e.g. when N is an integer). Each even-numbered ion KE range may be between the adjacent odd-numbered ion KE ranges. Each odd-numbered ion KE range may be between the adjacent even-numbered ion KE ranges. In other words, for example, an N^{th} ion KE range may be between an (N−1)^{th} ion KE range and an (N+1)^{th} ion KE range (e.g. when N is an integer).

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A method of operating an electrostatic ion trap, the electrostatic ion trap including a plurality of electrodes,
the method including setting the voltage of the plurality of electrodes to a first voltage map,
wherein the first voltage map is configured such that:
at a first ion kinetic energy per unit charge (KE) range, more than a first percentage of ions are stable,
at a second ion KE range, less than a second percentage of ions are stable, and
at a third ion KE range, more than the first percentage of ions are stable,
wherein the first percentage is at least 4 times greater than the second percentage,
and wherein the second ion KE range is between the first ion KE range and the third ion KE range.

2. The method of operating an electrostatic ion trap according to any claim 1,
wherein the first percentage is at least: 50; or 60; or 70; or 80; or 90 percent; and/or
wherein the first percentage is at least: 10; or 20; or 100 times greater than the second percentage.

3. The method of operating an electrostatic ion trap according to claim, wherein the method further includes introducing a first ion into the electrostatic ion trap at a first ion KE and obtaining first CDMS data indicative of the first ion.

4. (canceled)

5. The method of operating an electrostatic ion trap according to claim, wherein the first ion is introduced into the electrostatic ion trap through an ion energy filter(s) having a first acceptance ion KE range corresponding to the first ion KE range and/or a second acceptance ion KE range corresponding to the third ion KE range.

6. The method of operating an electrostatic ion trap according to claim, wherein the first ion is a reference ion of known mass-to-charge ratio and/or ion mass and/or ion charge.

7. The method of operating an electrostatic ion trap according to claim 3, wherein the first ion KE is within the first or third ion KE range.

8. The method of operating an electrostatic ion trap according to claim 3, wherein the method further includes changing the first voltage map to a second voltage map, such that the first ion KE is changed to a first adjusted ion KE, and, optionally, wherein the first adjusted ion KE is within the first or third ion KE range.

9. The method of operating an electrostatic ion trap according to claim 7, further including obtaining second CDMS data indicative of the first adjusted ion KE.

10. The method of operating an electrostatic ion trap according to claim 3, wherein the first ion is introduced into the electrostatic ion trap from a first ion source.

11. The method of operating an electrostatic ion trap according to claim 3, wherein the method further includes introducing a second ion into the electrostatic ion trap at a second ion KE.

12. The method of operating an electrostatic ion trap according to claim 10, wherein the method further includes obtaining third CDMS data indicative of the first ion and the second ion simultaneously.

13. The method of operating an electrostatic ion trap according to claim 10, wherein the second ion is introduced into the electrostatic ion trap through the ion energy filter(s) having the first acceptance ion KE range corresponding to the first ion KE range and/or the second acceptance ion KE range corresponding to the third ion KE range.

14. The method of operating an electrostatic ion trap according to claim 10, wherein the second ion is a reference ion of known mass-to-charge ratio and/or ion mass and/or ion charge.

15. The method of operating an electrostatic ion trap according to claim 10, wherein the second ion KE is within the first or third ion KE range.

16. The method of operating an electrostatic ion trap according to claim 10,
wherein the first ion KE is within the first ion KE range and the second ion KE is within the third ion KE range; or
wherein the first ion KE is within the third ion KE range and the second ion KE is within the first ion KE range.

17. The method of operating an electrostatic ion trap according to claims 10, wherein the method further includes changing the first voltage map to the second voltage map, such that the first ion KE is changed to the first adjusted ion KE, and/or the second ion KE is changed to a second adjusted ion KE, and, optionally, wherein the first adjusted ion KE is within the first or third ion KE range and/or the second adjusted ion KE is within the first or third ion KE range.

18. The method of operating an electrostatic ion trap according to claim 16, further including obtaining fourth CDMS data indicative of the first adjusted ion KE and the second ion adjusted ion KE simultaneously.

19. The method of operating an electrostatic ion trap according to claim 10, wherein the electrostatic ion trap has a first end and a second end, and wherein the method further includes:
introducing the first ion into the electrostatic ion trap and then introducing the second ion into the electrostatic ion trap at the second end when the first ion is at the first end of the electrostatic ion trap; or
introducing the first ion into the electrostatic ion trap and then introducing the second ion into the electrostatic ion trap at the first end when the first ion is at the second end of the electrostatic ion trap.

20. (canceled)

21. A computer readable medium having instructions stored thereon or a computer program including instructions which, when executed by a processor, cause the performance of the method of claim 1.

22. (canceled)

23. (canceled)

24. (canceled)

25. A mass spectrometer system including at least one processor and a computer readable medium, wherein the computer readable medium has instructions stored thereon which, when executed by the at least one processor, cause the mass spectrometer system to perform the method of claim 1.
